(19) United States
(12) Patent Application Publication
(10) Pub. No.: US 2023/0139521 A1
(43) Pub. Date: May 4, 2023

(54) NEURAL NETWORK VALIDATION SYSTEM

(71) Applicant: GM Global Technology Operations LLC, Detroit, MI (US)

(72) Inventors: Wei Tong, Troy, MI (US); Shige Wang, Northville, MI (US); Ramesh Sethu, Troy, MI (US); Jeffrey D. Scheu, Clarkston, MI (US); Prashanth Radhakrishan, Troy, MI (US); Upali P. Mudalige, Oakland Township, MI (US); Ryan Ahmed, LaSalle (CA)

(21) Appl. No.: 17/517,260

(22) Filed: Nov. 2, 2021

(51) Int. Cl. G05D 1/02; G06K 9/62; G06N 3/04

(52) U.S. Cl. CPC G05D 1/0291; G06K 9/6259; G06K 9/6265; G06N 3/0454

(57) ABSTRACT

A system comprises a computer including a processor and a memory. The memory includes instructions such that the processor is programmed to: receive, at a first neural network, unlabeled sensor data, wherein the first neural network generates output based on the unlabeled sensor data, receive, at a second neural network, the unlabeled sensor data, wherein the second neural network generates output based on the unlabeled sensor data during a validation mode, the second neural network different from the first neural network, compare the output generated by the first neural network with the output generated by the second neural network, and generate an alert when a difference between the output generated by the first neural network and the output generated by the second neural network is greater than a predetermined comparison threshold.

### INTRODUCTION

The present disclosure relates to validating, e.g., cross-checking, neural network output with output from multiple other neural network models.

Deep neural networks (DNNs) can be used to perform many image understanding tasks, including classification, segmentation, and captioning. Typically, DNNs require large amounts of training images (tens of thousands to millions). Additionally, these training images typically need to be annotated, e.g., labeled, for the purposes of training and prediction.

### SUMMARY

A system comprises a computer including a processor and a memory. The memory includes instructions such that the processor is programmed to: receive, at a first neural network, unlabeled sensor data, wherein the first neural network generates output based on the unlabeled sensor data, receive, at a second neural network, the unlabeled sensor data, wherein the second neural network generates output based on the unlabeled sensor data during a validation mode, the second neural network different from the first neural network, compare the output generated by the first neural network with the output generated by the second neural network, and generate an alert when a difference between the output generated by the first neural network and the output generated by the second neural network is greater than a predetermined comparison threshold.

In other features, the processor is further programmed to receive a selection to transition between the validation mode and a feature mode.

In other features, the processor is further programmed to operate at least one vehicle actuator based on the output generated by the first neural network during the feature mode.

In other features, the selection is transmitted from a server.

In other features, the selection is transmitted from an electronic controller unit of a vehicle.

In other features, the first neural network is trained using a first dataset and the second neural network is trained using a second dataset, wherein the second dataset is different from the first dataset.

In other features, the processor is further programmed to prevent the output generated by the first neural network from being used to operate a vehicle during the validation mode.

In other features, the unlabeled sensor data comprises sensor data collected by a fleet of vehicles.

A vehicle includes a system. The system comprises a computer including a processor and a memory. The memory includes instructions such that the processor is programmed to: receive, at a first neural network, unlabeled sensor data, wherein the first neural network generates output based on the unlabeled sensor data, receive, at a second neural network, the unlabeled sensor data, wherein the second neural network generates output based on the unlabeled sensor data during a validation mode, the second neural network different from the first neural network, compare the output generated by the first neural network with the output generated by the second neural network, and generate an alert when a difference between the output generated by the first neural network and the output generated by the second neural network is greater than a predetermined comparison threshold.

In other features, the processor is further programmed to receive a selection to transition between the validation mode and a feature mode.

In other features, the processor is further programmed to operate at least one vehicle actuator of the vehicle based on the output generated by the first neural network during the feature mode.

In other features, the selection is transmitted from a server.

In other features, the selection is transmitted from an electronic controller unit of the vehicle.

In other features, the first neural network is trained using a first dataset and the second neural network is trained using a second dataset, wherein the second dataset is different from the first dataset.

In other features, the processor is further programmed to prevent the output generated by the first neural network from being used to operate a vehicle during the validation mode.

In other features, the unlabeled sensor data comprises sensor data collected by a fleet of vehicles.

A method includes receiving, at a first neural network, unlabeled sensor data, wherein the first neural network generates output based on the unlabeled sensor data, receiving, at a second neural network, the unlabeled sensor data, wherein the second neural network generates output based on the unlabeled sensor data during a validation mode, the second neural network different from the first neural network, comparing the output generated by the first neural network with the output generated by the second neural network, and generating an alert when a difference between the output generated by the first neural network and the output generated by the second neural network is greater than a predetermined comparison threshold.

In other features, the method includes receiving a selection to transition between the validation mode and a feature mode.

In other features, the method includes operating at least one vehicle actuator based on the output generated by the first neural network during the feature mode.

In other features, the selection is transmitted from a server.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of a vehicle system that includes a validation network for comparing an output generated by a first neural network with outputs generated by a plurality of neural networks;

FIG. 2 is a block diagram of an example server within the system;

FIG. 3 is a diagram of an example neural network;

FIG. 4 is a block diagram of an example validation network; and

FIG. 5 is a flow diagram illustrating an example process for validating output generated by a neural network.

### DETAILED DESCRIPTION

The following description is merely exemplary in nature and is not intended to limit the present disclosure, application, or uses.

Typically, standard deep neural networks (DNNs) are pre-trained with labeled training datasets. These DNNs can be validated during testing by comparing the output of the model to ground truth. However, obtaining ground truth data can be difficult in real-world testing scenarios. Additionally, testing of the DNNs may reveal that further analysis is needed to identify a root cause of incorrect DNN output.

The present disclosure discloses a neural network validation system in which output generated by a neural network is compared with output generated by validation neural networks. The validation neural networks can be trained on different datasets that can be partial observations with different bias from the real-world underlying distribution. For example, the validation neural networks can comprise a different architecture with respect to the architecture of the neural network of interest.

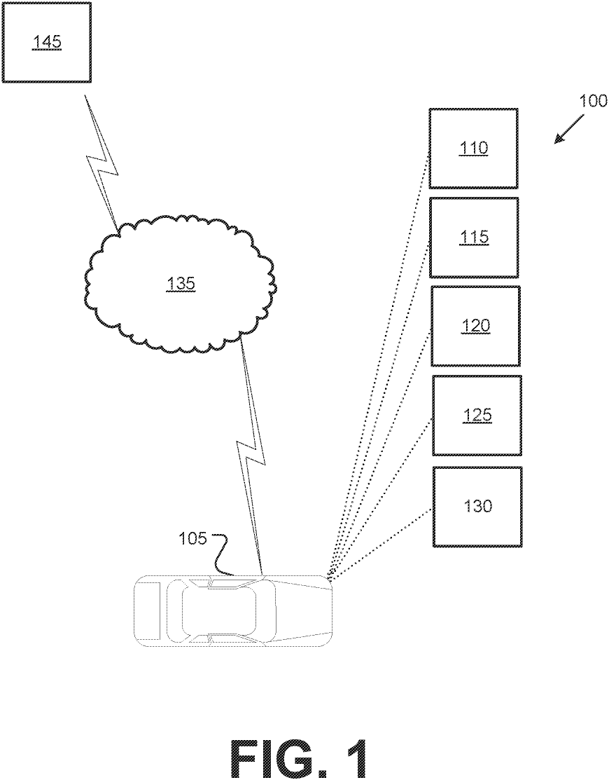

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

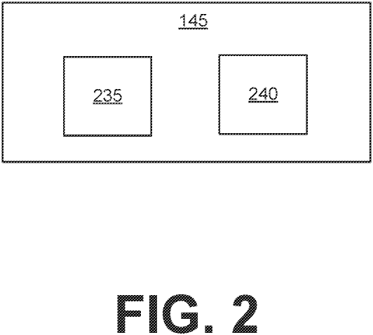

FIG. 2 is a block diagram of an example server 145. The server 145 includes a computer 235 and a communications module 240. The computer 235 includes a processor and a memory. The memory includes one or more forms of computer readable media, and stores instructions executable by the computer 235 for performing various operations, including as disclosed herein. The communications module 240 allows the computer 235 to communicate with other devices, such as the vehicle 105.

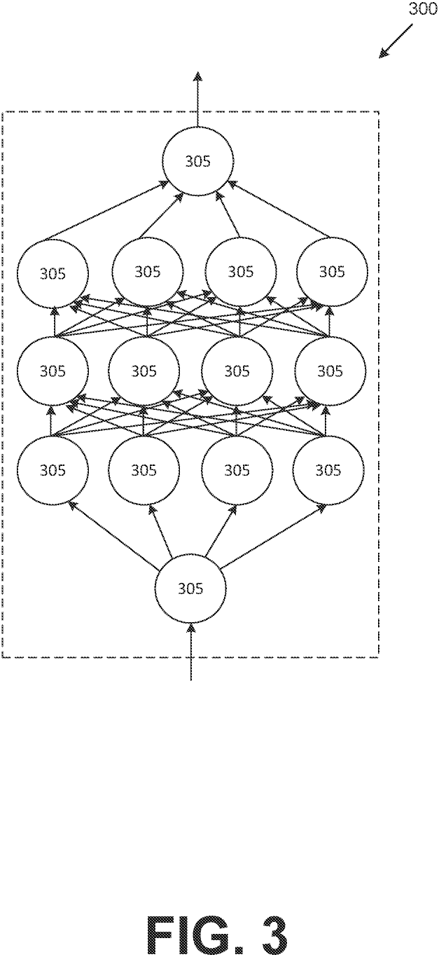

FIG. 3 is a diagram of an example deep neural network (DNN) 300 that may be used herein. The DNN 300 includes multiple nodes 305, and the nodes 305 are arranged so that the DNN 300 includes an input layer, one or more hidden layers, and an output layer. Each layer of the DNN 300 can include a plurality of nodes 305. While FIG. 3 illustrates three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to activation function, which in turn provides a connected neuron 305 an output. The activation function can be a variety of suitable functions, typically selected based on empirical analysis. As illustrated by the arrows in FIG. 3, neuron 305 outputs can then be provided for inclusion in a set of inputs to one or more neurons 305 in a next layer.

The DNN 300 can be trained to accept data as input and generate an output based on the input. In one example, the DNN 300 can be trained with ground truth data, i.e., data about a real-world condition or state. For instance, the DNN 300 can be trained with ground truth data or updated with additional data by a processor. Weights can be initialized by using a Gaussian distribution, for example, and a bias for each node 305 can be set to zero. Training the DNN 300 can including updating weights and biases via suitable techniques such as backpropagation with optimizations. Ground truth data can include, but is not limited to, data specifying objects within an image or data specifying a physical parameter, e.g., angle, speed, distance, color, hue, or angle of object relative to another object. For example, the ground truth data may be data representing objects and object labels.

Machine learning services, such as those based on Recurrent Neural Networks (RNNs), Convolutional Neural Networks (CNNs), Long Short-Term Memory (LSTM) neural networks, or Gated Recurrent Unit (GRUs) may be implemented using the DNNs 300 described in this disclosure. In one example, the service-related content or other information, such as words, sentences, images, videos, or other such content/information may be translated into a vector representation.

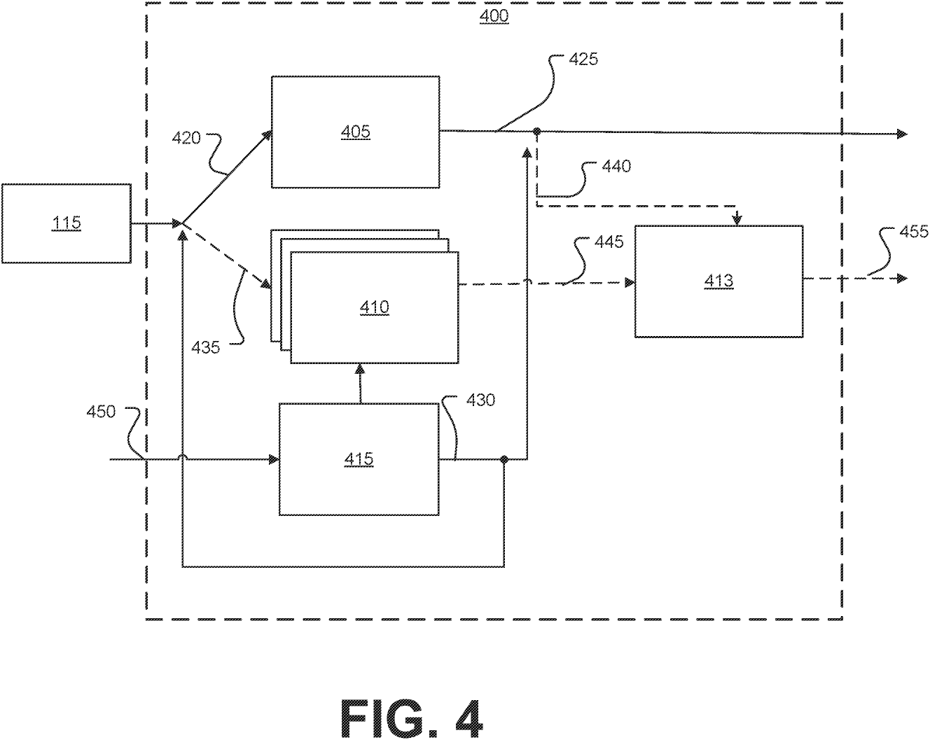

FIG. 4 is a diagram of an example validation network 400 for comparing an output generated by a neural network 405, e.g., a first neural network, with outputs generated by one or more validation neural networks 410, e.g., a plurality of second neural networks. For example, during a validation mode, the validation network 400 compares the output generated by the neural network 405 with output by the validation neural networks 410 using the same input data. The input data may comprise unlabeled training data. In this example, the validation neural networks 410 may be trained using training data not used to train the neural network 405.

It is understood that the neural network 405 and the validation neural networks 410 may comprise any suitable deep neural network 300. As shown, the validation network 400 includes the neural network 405, the validation neural networks 410, a comparison module 413, and a selector module 415. The validation network 400 can be a software program that can be loaded in memory and executed by a processor in the computer 110 and/or the server 145, for example.

The selector module 415 can cause the validation network 400 to operate in feature mode or in validation mode. In feature mode, the neural network 405 receives sensor data from one or more sensors 115 via data path 420 and generates output via data path 425 based on the received sensor data. For example, the neural network 405 may comprise a CNN that receives images captured by one or more image sensors 115 via data path 420 and performs object classification based on the images. The output indicative of the object classification can be provided to one or more other software modules via the data path 425, and the software modules can generate control instructions for vehicle 105 operation. For instance, based on the object classification, the software modules can generate control instructions that are provided to one or more actuators 120 to control operation of the vehicle 105.

In validation mode, the selector module 415 sends control instructions via control path 430 such that the validation neural networks 410 receive the sensor data via data path 435. The selector module 415 also sends control instructions via the data path 430 such that the output generated by the neural network 405 is received by the comparison module 413 via data path 440. Thus, the validation neural networks 410 can generate output based on the same sensor data received by the neural network 405, i.e., the same input.

The comparison module 413 compares the output generated by the validation neural networks 410 with the output generated by the neural network 405. Based on the comparison, the comparison module 413 generates a comparison output indicative of the difference between the neural network 405 output and the validation neural network 410 output(s) via data path 445. The comparison module 413 compares the comparison output with a predetermined comparison threshold to determine whether the comparison output is greater than the predetermined comparison threshold. The predetermined comparison threshold may be selected based on empirical analysis.

If the comparison output is greater than the predetermined comparison threshold, the comparison module 413 generates an alert and transmits the alert and the neural network 405 output to the server 145. For example, the comparison module 413 can generate the alert to indicate that the comparison output is greater than the predetermined comparison threshold for further review purposes. In various implementations, the neural network 405 can operate in parallel with the validation neural networks 410.

If the comparison output is less than or equal to the predetermined comparison threshold, the comparison module 413 transmits the comparison output to the server 145. The server 145 may initiate an update for one or more neural networks 405 based on the comparison output, such as causing the neural network 405 to update corresponding weights and biases using a loss function that incorporates the comparison output.

In the validation mode, the neural network 405 receives unlabeled training data. For example, the unlabeled training data may comprise sensor data collected by a fleet of vehicles that has been uploaded to the server 145. In these implementations, the ground truth data for the output generated by the neural network 405 is the output generated by the validation neural networks 410 based on the same received sensor data. As such, the neural network 405 output may not be provided to the software modules for vehicle decision making during the validation mode.

As discussed above, the validation neural networks 410 can comprise neural networks having a different architecture with respect to the neural network 405. For example, the validation neural networks 410 may be trained with datasets that differ with respect to the datasets used to train the neural network 405.

In some implementations, the selector module 415 can determine whether to operate the vehicle in feature mode or in validation mode based on input received via data path 450. For example, the server 145 may transmit control instructions to the selector module 415 to cause the selector module 415 to transition between the feature mode and the validation mode. In other examples, the processor of the computer 110 may send control instructions to the selector module 415 to cause the selector module 415 to transition between the feature mode and the validation mode.

In various implementations, the validation network 400 may be deployed as a microservice. The computer 110 may store the validation neural networks 410 in memory and load the validation neural networks 410 when invoked by the selector module 415.

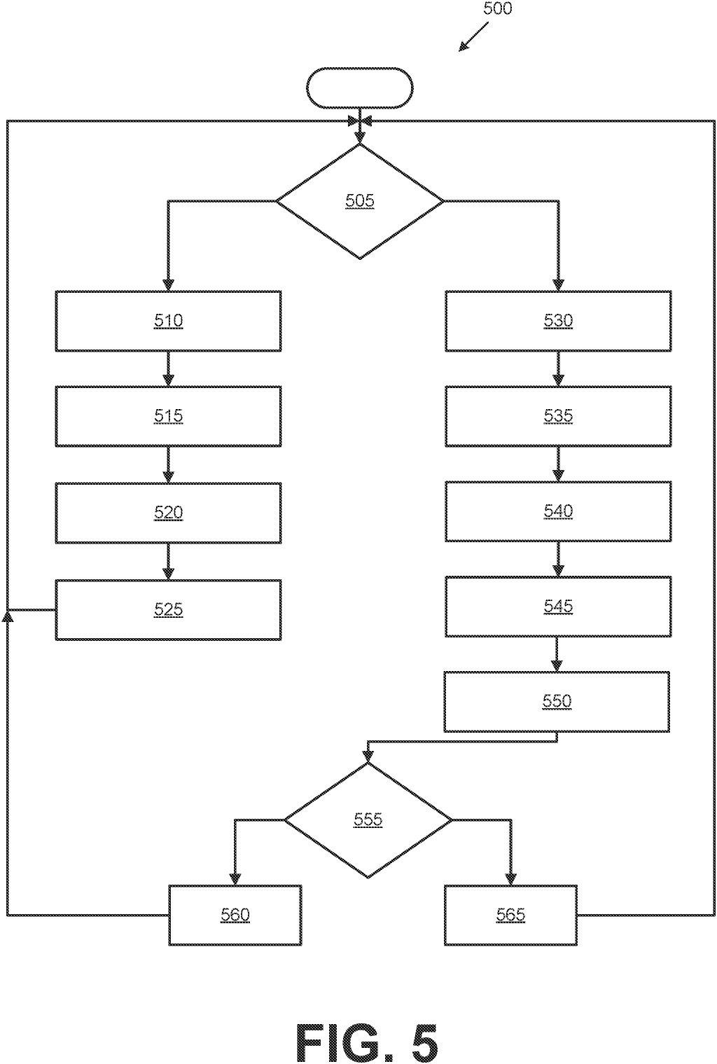

FIG. 5 is a flowchart of an example process 500 for validating output of the neural network 405 during the validation mode. Blocks of the process 500 can be executed by the computer 110. The process 500 begins at block 505 in which a determination is made whether the validation mode has been enabled. For example, the validation mode is enabled based on input received by the selector module 415. The input may be provided by the server 145 or another ECU.

If the validation mode is not enabled, the neural network 405 is loaded to operate in feature mode at block 510. In feature mode, the neural network 405 can generate output based on sensor data. This output can be used by one or more software modules to at least partially operate the vehicle 105, i.e., control steering, acceleration, braking, etc.

At block 515, the computer 110 initiates one or more communication protocols for feature mode operation. For example, the computer 110 can initiate one or more gateway modules for interoperability purposes. The gateway modules can allow data to flow between the various communication networks within the vehicle 105, such as a sensor gateway and/or an actuator gateway.

At block 520, the computer 110 operates the neural network 405 in feature mode. For example, the neural network 405 receives sensor data from the sensors 115 and generates output based on the sensor data. As discussed above, the neural network 405 can be trained for object classification in one implementation, and the neural network 405 outputs object classification data based on the sensor input. Using the object classification data, one or more software modules employed by the computer 110 can assist in vehicle operation. At block 525, the vehicle 105 is operated based on the output from the neural network 405. For example, one or more software modules may generate control instructions that are sent to the actuators 120 to operate one or more components 125 of the vehicle 105 based on the neural network 405 output. The process 500 then transitions back to block 505.

If the validation mode is enabled, one or more vehicle 105 actuators 120 are disengaged from the neural network 405 at block 530. For example, if the selector module 415 receives input to select the validation mode, the software modules and/or corresponding gateway modules may be disabled to prevent output from the neural network 405 from operating the vehicle 105.

At block 535, the computer 110 loads the validation neural networks 410. For example, the computer 110 may access and load the validation neural networks 410 into memory for validating purposes. At block 540, the computer 110 reconfigures sensor data provided to one or more neural networks 405, 410. For example, depending on the type of unlabeled sensor data received for validation purposes, one or more neural network configurations may need to be modified. The computer 110 may modify the neural network configuration based on a configuration file provided by the server 145 and/or a configuration file stored in memory.

At block 545, the computer 110 causes the validation network 400 to compare the output generated by the neural network 405 with output generated by one or more validation neural networks 410. It is understood that multiple validation neural networks 410 may be used in which the output of the neural network 405 is compared with corresponding outputs from each validation neural network 410. At block 550, the comparison module 413 compares the output from the neural network 405 with the output from the validation neural networks 410. At block 555, the comparison module determines whether the comparison output is greater than the predetermined comparison threshold. If the comparison output is greater than the predetermined comparison threshold, the comparison module 413 generates transmits the alert and the comparison data to the server 145 at block 560. The process 500 then transitions back to block 505. If the comparison output is not greater than the predetermined comparison threshold, the comparison module 413 transmits the comparison output to the server 145 at block 565. The process 500 then transitions back to block 505.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
receive, at a first neural network, unlabeled sensor data, wherein the first neural network generates output based on the unlabeled sensor data;
receive, at a second neural network, the unlabeled sensor data, wherein the second neural network generates output based on the unlabeled sensor data during a validation mode, the second neural network different from the first neural network;
compare the output generated by the first neural network with the output generated by the second neural network; and
generate an alert when a difference between the output generated by the first neural network and the output generated by the second neural network is greater than a predetermined comparison threshold.

2. The system of claim 1, wherein the processor is further programmed to receive a selection to transition between the validation mode and a feature mode.

3. The system of claim 2, wherein the processor is further programmed to operate at least one vehicle actuator based on the output generated by the first neural network during the feature mode.

4. The system of claim 2, wherein the selection is transmitted from a server.

5. The system of claim 2, wherein the selection is transmitted from an electronic controller unit of a vehicle.

6. The system of claim 1, wherein the first neural network is trained using a first dataset and the second neural network is trained using a second dataset, wherein the second dataset is different from the first dataset.

7. The system of claim 1, wherein the processor is further programmed to prevent the output generated by the first neural network from being used to operate a vehicle during the validation mode.

8. The system of claim 1, wherein the unlabeled sensor data comprises sensor data collected by a fleet of vehicles.

9. A vehicle including a system, the system comprising a computer including a processor and a memory, the memory including instructions such that the processor is programmed to:
receive, at a first neural network, unlabeled sensor data, wherein the first neural network generates output based on the unlabeled sensor data;
receive, at a second neural network, the unlabeled sensor data, wherein the second neural network generates output based on the unlabeled sensor data during a validation mode, the second neural network different from the first neural network;
compare the output generated by the first neural network with the output generated by the second neural network; and
generate an alert when a difference between the output generated by the first neural network and the output generated by the second neural network is greater than a predetermined comparison threshold.

10. The vehicle of claim 9, wherein the processor is further programmed to receive a selection to transition between the validation mode and a feature mode.

11. The vehicle of claim 10, wherein the processor is further programmed to operate at least one vehicle actuator of the vehicle based on the output generated by the first neural network during the feature mode.

12. The vehicle of claim 10, wherein the selection is transmitted from a server.

13. The system of claim 10, wherein the selection is transmitted from an electronic controller unit of the vehicle.

14. The system of claim 9, wherein the first neural network is trained using a first dataset and the second neural network is trained using a second dataset, wherein the second dataset is different from the first dataset.

15. The system of claim 9, wherein the processor is further programmed to prevent the output generated by the first neural network from being used to operate a vehicle during the validation mode.

16. The system of claim 9, wherein the unlabeled sensor data comprises sensor data collected by a fleet of vehicles.

17. A method comprising:
receiving, at a first neural network, unlabeled sensor data, wherein the first neural network generates output based on the unlabeled sensor data;
receiving, at a second neural network, the unlabeled sensor data, wherein the second neural network generates output based on the unlabeled sensor data during a validation mode, the second neural network different from the first neural network;
comparing the output generated by the first neural network with the output generated by the second neural network; and
generating an alert when a difference between the output generated by the first neural network and the output generated by the second neural network is greater than a predetermined comparison threshold.

18. The method of claim 17, further comprising receiving a selection to transition between the validation mode and a feature mode.

19. The method of claim 18, further comprising operating at least one vehicle actuator based on the output generated by the first neural network during the feature mode.

20. The system of claim 18, wherein the selection is transmitted from a server.
